(19) United States
(12) Patent Application Publication
(10) Pub. No.: US 2026/0329795 A1
(43) Pub. Date: Oct. 22, 2026

(54) APPLICATION INTERFACE MODULE WITH MANAGEMENT PASSTHROUGH

(71) Applicant: Dell Products L.P., Round Rock, TX (US)

(72) Inventors: Padmanabhan Narayanan, Chennai (IN); Mohanapriya Meganathan, Tiruvallur (IN); Gokulnath Raja, Tamilnadu (IN)

(21) Appl. No.: 19/181,958

(22) Filed: Apr. 17, 2025

(51) Int. Cl. G06F 13/40

(52) U.S. Cl. CPC G06F 13/4022; G06F 2213/0042

(57) ABSTRACT

A network switch configured to receive an application interface module (AIM) includes a chassis, a network switchboard, fans coupled to the network switchboard, a network processing unit (NPU) coupled to the network switchboard, multiple network ports coupled to the NPU, and a passage extending from the front surface of the network switch into the chassis of the network switch. Additionally, the AIM includes a chassis with an open top and open back, an AIM switchboard, an AIM edge connector, and multiple network ports.

### BACKGROUND

Users may use network switches. The network switches may be located on server racks. The network switches may be used to connect multiple devices through wired or wireless connections.

### BRIEF DESCRIPTION OF DRAWINGS

FIG. 1.1 shows a diagram of a modular network switch with a passage in accordance with one or more embodiments of the disclosure.

FIG. 1.2 shows a diagram of a network switch switchboard that supports an application interface module (AIM) in accordance with one or more embodiments of the disclosure.

FIG. 2.1 shows a side view of an AIM in accordance with one or more embodiments of the disclosure.

FIG. 2.2 shows an isometric front view of an AIM in accordance with one or more embodiments of the disclosure.

FIG. 2.3 shows an AIM Passthrough (AIM-P) switchboard in accordance with one or more embodiments of the disclosure.

FIG. 3 shows an AIM Telemetry (AIM-T) switchboard in accordance with one or more embodiments of the disclosure.

FIG. 4 shows a flowchart for a method for assembling a network switch with an AIM in accordance with one or more embodiments of the disclosure.

FIG. 5 shows a diagram of a computing device in accordance with one or more embodiments of the disclosure.

### DETAILED DESCRIPTION

In server environments, minimizing vertical clearance requirements and maximizing network switch runtime imposes significant challenges in efforts to optimize networking capabilities. Conversely, fixed and inflexible network switches increase downtime due to a requirement to replace rather than modify the network switch. Traditional solutions struggle to optimize both runtime and vertical clearance. Further, some traditional solutions force choosing between runtime or vertical clearance. As a non-limiting example, a traditional solution where the top of a network switch chassis is removed for modification requires clearance space to remove the top portion of the chassis. These traditional solutions result in wasted space or decreased runtime, leading to inefficiencies and suboptimal performance.

Further, the traditional solutions often require specialized operators or manufacturing experience to modify the network switches. One or more traditional solutions often require returning a functional network switch back to the manufacturer to modify per changing circumstances. This adds to the inflexibility of the traditional solutions as it discourages or often prohibits network switch modification. Based on the above, there is a need in the industry to provide more flexibility and modularity in the network switch creation.

In light of the above issues within the traditional approaches, this disclosure provides a system for a modified network switch by manufacturing a modular network switch chassis with an integrated slot that can receive an application interface module (AIM). In doing so, the disclosure provided herein incorporates a modular approach, via the AIM, to increase run-time and provide greater flexibility by relegating certain out-of-band management ports to the modular AIM. In one or more embodiments, out-of-band is a separate, dedicated management network that enables accessed even when a primary network is unavailable. In one or more embodiments, out-of-band management ports run parallel to other existing network ports but do not share the same infrastructure. This system operates by identifying client network switch needs, identifying the specific AIM to fulfill the aforementioned needs, and inserting the specific AIM into the modified network switch to obtain a complete network switch.

Specific embodiments will now be described with reference to the accompanying figures.

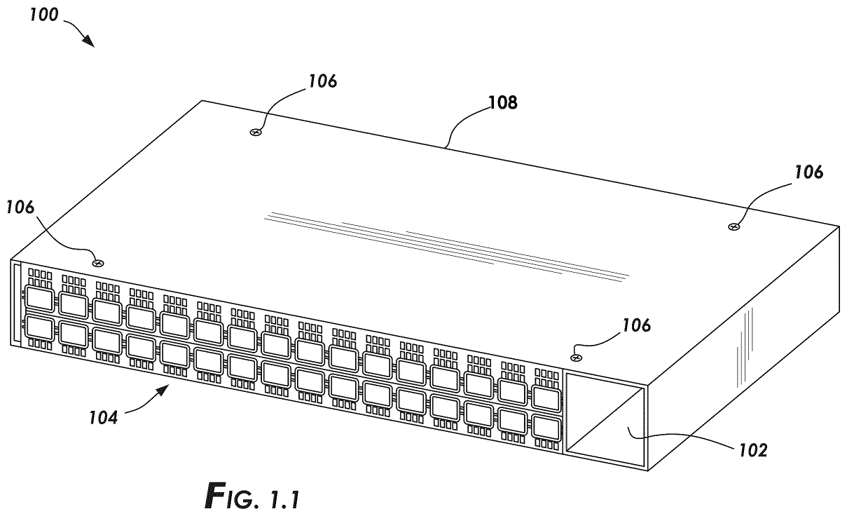

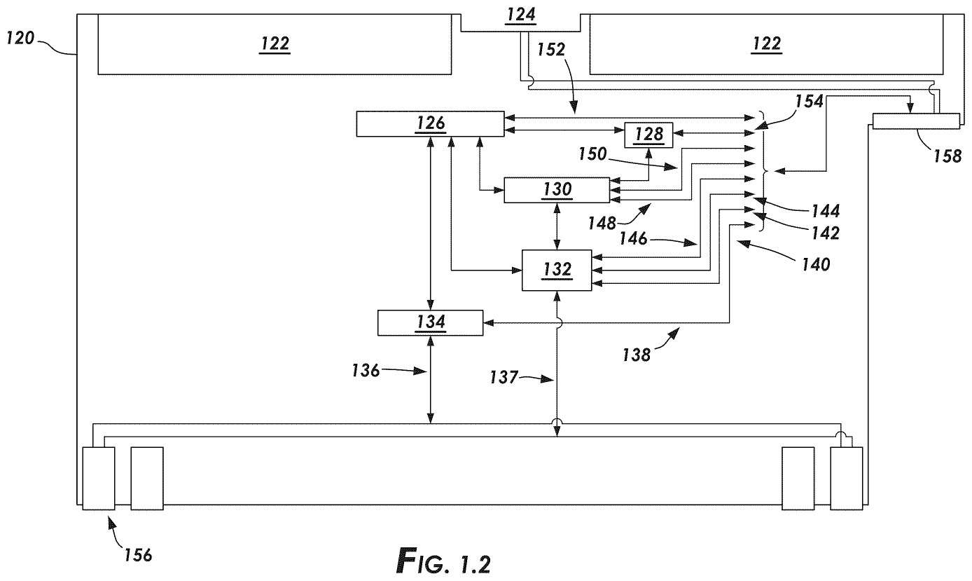

FIG. 1.1 shows a diagram of a modular network switch (100) with a passage (102) in accordance with one or more embodiments of the disclosure. In one or more embodiments, the modular network switch (100) includes the aforementioned passage (102), an array of ports (104), a series of fasteners (106), and a chassis (108). The modular network switch (100) may include fewer or additional components without departing from the scope of the disclosure. As a non-limiting example, the network switch (100) may contain a switchboard (FIG. 1.2, 120).

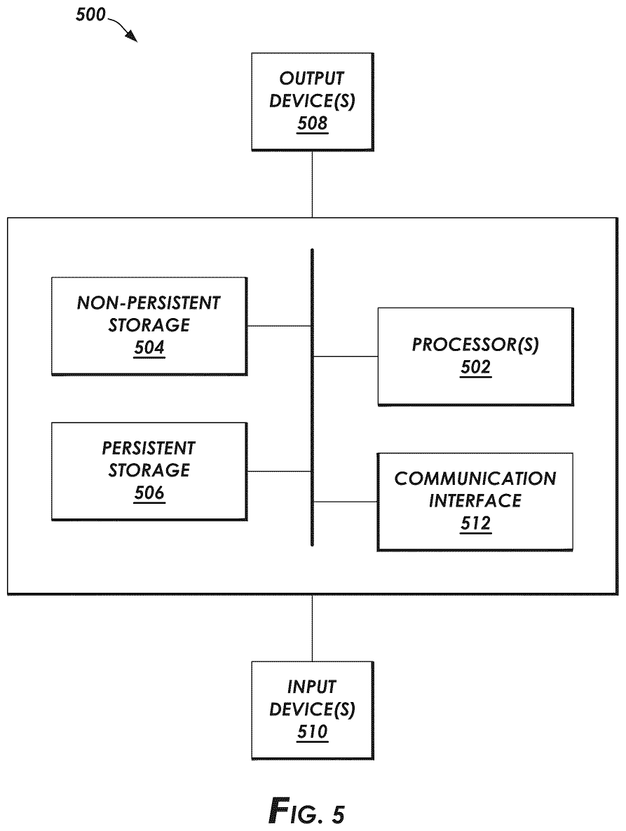

In one or more embodiments, the modular network switch (100) may be a physical networking hardware device. It may include the functionality to operatively connect to other devices (e.g., FIGS. 5, 500) through a network (not shown) (e.g., a local area network (LAN), a wide area network (WAN) such as the Internet, a mobile network, any other network type, or a combination thereof). Further, the modular network switch (100) may communicate with other components and devices using any combination of wired and/or wireless communication protocols. In one or more embodiments, the modular network switch (100) may include the functionality to facilitate communications between the aforementioned components and devices. Further, in one or more embodiments the modular network switch (100) may include the functionality to forward data packets to specific devices that are a subset of the connected devices associated with the modular network switch (100). In one or more embodiments, the modular network switch (100) may include the functionality to be modified or accept modular components to modify the physical connection mediums (e.g., ports) to expand functionality. The modular network switch (100) may include additional functionality without departing from the scope of the disclosure.

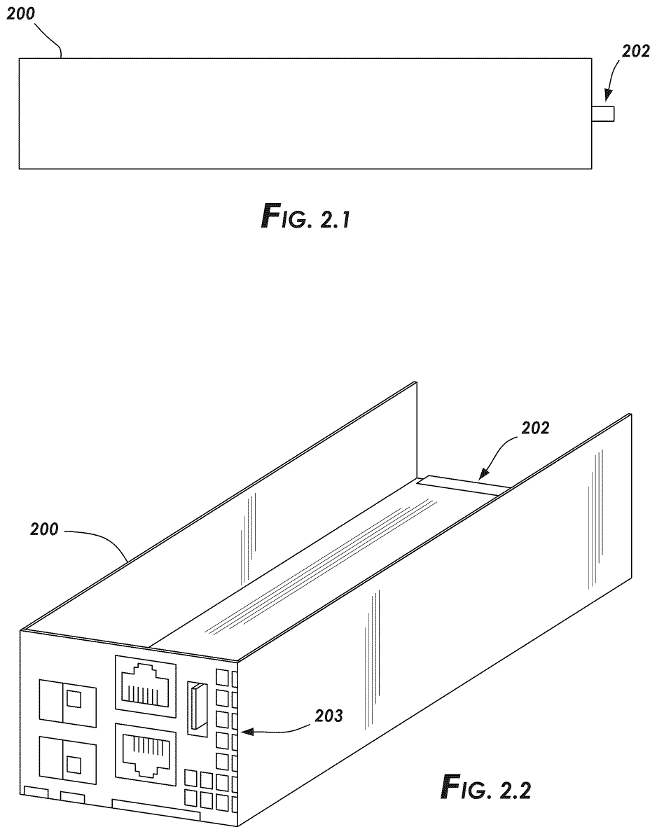

In one or more embodiments, the passage (102) is an empty cavity or section in the modular network switch (100) and includes the functionality to receive an external or modular device (e.g., Application Interface Module (AIM), FIG. 2.1, 200). In one or more embodiments, the cavity may span a portion of the depth of the network switch chassis (108), starting at the front face, coplanar to the ports (e.g., 104) and extending part way into the network switch chassis (108) such that the passage (102) ends at the AIM Chassis Connector (FIG. 1.2, 158). Said another way, the passage (102) spans the distance between the AIM Chassis Connector (FIG. 1.2, 158) and the front face of the modular network switch (100).

In one or more embodiments, the open face of the passage (102) extends the full vertical extent of the front face of the network switch (100), as shown. However, it should be appreciated that the face of the passage (102) may extend only partially along the vertical extent of the front face of the network switch (100). For example, the passage (102) may only extend halfway along the vertical extent of the front face of the network switch (100). In one or more embodiments, the passage (102) also extends partially along the width of the network switch (100). For example, the passage (102) extends sufficiently far along the width of the network switch (100) to accommodate a port array such as the one shown in FIG. 2.2. However, it should be appreciated that the passage (102) may extend further or lesser to accommodate other arrangements of port arrays.

In one or more embodiments, the array of ports (104) may be physical hardware connection devices (e.g., access ports, trunk ports, hybrid ports, etc.) which, when connected to a device, include the functionality to transmit data and enable communication between devices. In one or more embodiments, the array of ports (104) also includes the functionality to connect to other devices via using any combination of wired and/or wireless communication protocols. Further, in one or more embodiments, the array of ports (104) may be directly connected to the network switch switchboard (FIG. 1.2, 120) through soldering. Any direct connection method may be used without departing from the scope of the disclosure. In this manner, the array of ports (104) may be limited in quick modification and, accordingly, represent a standard mix of port types (e.g., access ports, trunk ports, hybrid ports, etc.) included with each modular network switch (100).

In one or more embodiments, the fasteners (106) may be metal screws used to tighten the top component (e.g., lid) of the chassis (108) to protect the internal components and prevent unnecessary and/or accidental access. In one or more embodiments, the fasteners (106) may be made of any material without departing from the scope of the disclosure. Further, the fasteners may use a different fastening mechanism other than a screw (e.g., clip, glue, welding, rivet, etc.) without departing from the scope of the disclosure. Any fastening mechanism may be used to seal the lid of the chassis (108) without departing from the scope of the disclosure.

In one or more embodiments, the chassis (108) may be a mechanical structure for housing components of the network switch (100). In one or more embodiments, the chassis (108) may be implemented as a rack mountable enclosure for housing components of the network switch (100). The chassis (108), in one or more embodiments, may have a sealed lid to protect the housed components. Due to sealed lid, internal access to the components maybe limited, which may be useful to prevent tampering, accidentally or otherwise, and protect the internal components during use and transport. To improve functionality, the chassis (108) may have a passage (102) discussed above, that includes the functionality to modify the housed components. As a non-limiting example, the chassis (108) may include space to house an ethernet port in the passage. When desired, the ethernet port may be removed and swapped with a different connection port without disrupting the chassis (108) or any other component housed in the chassis (108). Other components may be modified in this manner without departing from the scope of the disclosure.

Turning to FIG. 1.2, FIG. 1.2 shows a diagram of a network switch switchboard (120) that supports an application interface module (AIM) in accordance with one or more embodiments of the disclosure. In one or more embodiments, the network switch switchboard (120) includes an array of fan ports (122), a busbar connector (124), a central processing unit (CPU) (126), an ethernet controller (128), a baseboard management controller (BMC) (130), a field programmable gate array (FPGA) (132), a network processing unit (NPU) (134), an AIM Chassis Connector (158) and multiple interfacing connections between the components (e.g., circuitry (136-154)). Further, the network switch switchboard (120) may also include a series of ports (156). Each component is discussed in greater detail below.

In one or more embodiments, the network switch switchboard (120) may be physical hardware device (e.g., main circuit board). The network switch switchboard (120) may include the functionality to connect and allow communication between all other components to the network switch switchboard (120). Further, it may include the functionality to connect, either through wired or wireless means, to devices (e.g., fans). Additionally, the network switch switchboard (120) includes the functionality, in one or more embodiments, to provide power to all connected components.

In one or more embodiments, the array of fan ports (122) may be physical hardware connections on the network switch switchboard (120) that include the functionality to connect to a series of fans in the network switch (FIG. 1.1, 100). In one or more embodiments, the array of fan ports (122) includes the functionality to transmit power and fan speed instructions to the series of fans. Further, in one or more embodiments, the array of fan ports (122) may be physically connected to the busbar connector (124) to receive power. Additionally, the array of fan ports (122) may include the functionality to receive inputs from the CPU (126) to control the fan speed of the series of fans.

In one or more embodiments, the busbar connector (124) may be a physical hardware device that is a metallic conductor. It may include the functionality, in one or more embodiments, to connect with other electrical components (e.g., transformers, circuit breakers, power source, remotely located power supply, etc.) and other device components (e.g., network switch switchboard (120) components) to distribute power from the electrical components to the switchboard components. In one or more embodiments, the busbar connector (124) includes the functionality to serve as a central hub for power distribution on the network switch switchboard (120). The busbar connector (124) may include additional functionality without departing from the scope of the disclosure.

In one or more embodiments, the CPU (126) is a physical hardware component capable of executing instructions and performing calculations for the network switch (100). In one or more embodiments, the CPU (126) includes the functionality to output instructions to other components in the network switch switchboard (120) via the circuitry (e.g., the multiple interfacing connections (136-154)). Further, the CPU (126) may include the functionality to connect with, receive inputs, and transmit outputs to a modular device (e.g., AIM (FIG. 2.1, 200)) via the circuitry (e.g., 152) connecting to the AIM Chassis Connector (158) The CPU may include additional functionality without departing from the scope of the disclosure.

In one or more embodiments, the ethernet controller (128) is a physical hardware component capable of facilitating communication between the network switch switchboard (120) and an ethernet network. In one or more embodiments, the ethernet network may be provided over the AIM Chassis Connector (158) which is discussed below. Further, in one or more embodiments, the ethernet controller (128) may include the functionality to receive power and transmit data through the circuitry and connections (e.g., 136-154). on the switch board. The ethernet controller (128) may include additional functionality without departing from the scope of the disclosure.

In one or more embodiments, the baseboard management controller (BMC) (130) is a physical hardware component (e.g., microcontroller) capable of providing out-of-band management capabilities associated with the network switch switchboard (120). The BMC (130) may include the functionality to enable remote monitoring (e.g., alerts and logs), modification (e.g., server updates), and power control (e.g., power cycle, reboot, etc.) without needing to physically interact with the network switch (FIG. 1.1, 100). The BMC (130) may also include, in one or more embodiments, the functionality to verify and monitor any modular components (e.g., AIM) that connects to the network switch switchboard (120) through the AIM Chassis Connector (158). The BMC (130) may include additional functionality, such as remotely managing the connected modular components (e.g., AIM), without departing from the scope of the disclosure.

In one or more embodiments, the FPGA (132) is an integrated circuit capable of being dynamically programmed (i.e., re-programmed) and/or reconfigured for a particular use. That is, unlike other integrated circuits that may have a static configuration when manufactured (e.g., an application-specific integrated circuit (ASIC)), the FPGA (132) allows for the internal circuitry (i.e., the internal logical gates) to be configured, after manufacture, to suit a particular function. In one or more embodiments, the FPGA (132) is capable of performing parallel data operations. That is, as a non-limiting example, the FPGA (132) may accept and process two or more data operation concurrently.

In one or more embodiments the NPU (134) may be a specialized hardware component capable of performing network processing specific tasks (e.g., header parsing, packet modification, etc.). The NPU (134) may include the functionality, in one or more embodiments, to process large volumes of data at high speeds. Such processing may also include parallel processing to handle multiple independent data packets simultaneously. Further, the NPU (134) may include the functionality to process data packets sent from modular components (e.g., AIM) over the AIM Chassis Connector (158) and transmit information back to the modular components over the AIM Chassis Connector (158). The NPU (134) may include additional functionality without departing from the scope of the disclosure.

In one or more embodiments, the multiple interfacing connections (136-154) may be circuitry on the network switch switchboard (120) capable of transmitting power and data to connected components. The multiple interfacing connections (136-154) may include the functionality to transmit power and data to external connected devices via wired or wireless means. Further, in one or more embodiments, certain interfacing connections (e.g., 140-154) may include the functionality to transmit power and data to a modular component (e.g., AIM) and receive data back from the modular component, thereby enabling communication between components connected via the AIM Chassis Connector (158) and components on the network switch switchboard (120). The multiple interfacing connections (136-154) may include additional functionality, like bi-directional power draw and data transmission, without departing from the scope of the disclosure.

In one or more embodiments, each port in the series of ports (156) may be a physical connection point where end devices (computer, printers, etc.) can connect to the network via the network switch (FIG. 1.1, 100). In one or more embodiments, the series of ports (156) are the same as the ports (104) described above. The series of ports (156) may include the functionality to transmit and receive data. In one or more embodiments, the ports in the series of ports (156) may be different. As a non-limiting example, the series of ports may have multiple access ports, trunk ports, and hybrid ports. Other ports may also be included in the series of ports (156) without departing from the scope of the disclosure. Further, in one or more embodiments, the series of ports (156) may include the functionality to facilitate data transmission between end devices and the modular component (e.g., AIM) through the aforementioned circuitry (e.g., 140-154).

In one or more embodiments, the AIM Chassis Connector (158) is a physical connector capable of connecting to a modular component (e.g., AIM). The AIM Chassis Connector (158) may include the functionality to receive power and data from multiple components on the network switch switchboard (120) and transmit power and data to the connected modular component (e.g., AIM). Additionally, the AIM Chassis Connector (158) may receive data from the connected modular component (e.g., AIM) and transmit that data to other components or end devices connected to the switchboard (120). Said another way, the AIM Chassis Connector includes the functionality to facilitate power and data transmission between the switchboard (120) and the modular component (e.g., AIM). The AIM Chassis Connector may include additional functionality without departing from the scope of the disclosure.

Turning to FIG. 2.1, FIG. 2.1 shows a side view of an AIM (200) in accordance with one or more embodiments of the disclosure. In one or more embodiments, the AIM (200) may include an AIM Edge Connector (202). In one or more embodiments, the AIM (200) may include additional or fewer components without departing from the scope of the disclosure. The AIM (200) and its components are discussed in greater detail below.

In one or more embodiments, the AIM (200) is a physical hardware component capable of modifying the network switch (FIG. 1.1, 100) to add core or additional capabilities. The AIM (200) may include an AIM Edge Connector (202). The AIM may also include other components, such as various ports and light emitting diodes (LEDs), without departing from the scope of the disclosure. In one or more embodiments, the AIM (200) inserts into the passage (FIG. 1.1, 102) such that the front face of the AIM (e.g., port array (FIG. 2.2, 203)) sits flush, or coplanar, with the front face of the network switch (e.g., FIG. 1.1, 104). Further, the AIM (200) extends, in one or more embodiments, into the network switch chassis (FIG. 1.1, 108) such that the AIM Edge Connector (202) mates with the AIM Chassis Connector (FIG. 1.2, 158).

The AIM (200) may include the functionality, in one or more embodiments, to connect and receive power from the network switch (FIG. 1.1, 100) while receiving and transmitting data to the over network switch (100). Further, in one or more embodiments, the AIM (200) may connect and disconnect from the network switch (100) without changing the status of the network switch (100). Said another way, the AIM (200) may be removed or added to the network switch (100) without needing to power of the network switch (100), reboot components to enable functionality, or interrupt the operations of the network switch (100). While the following description of the AIM is intended to be general, in one or more embodiments, the AIM (200) can be modified or replaced with other AIM versions (e.g., AIM-P, AIM-T, etc.) without departing from the scope of the disclosure. Further, the AIM (200) may include the functionality to include application acceleration capabilities (e.g., Internet protocol security (IPSEC) or secure sockets layer (SSL) tunnel termination, telemetry, out-of-band statistics, precision time protocol, deep packet inspection, etc.). Some of these capabilities are discussed further below. In one or more embodiments, the AIM (200) also includes the functionality to capture network switch telemetry information. As used herein, network switch telemetry information is performance, status and/or health information associated with the network switch (FIG. 1.1, 100). In one or more embodiments, the network switch telemetry information can also include other types of data associated with the network switch (FIG. 1.1, 100). The AIM (200) may include additional functionality without departing from the disclosure.

In one or more embodiments, the AIM Edge Connector (202) is a physical hardware connector capable of mating to the AIM Chassis Connector (FIG. 1.2, 158). The AIM Edge Connection, in one or more embodiments, includes the functionality to receive power and data from the connection and transmit data through the connection to components on the network switch switchboard (FIG. 1.2, 120). The AIM Edge Connector (202) may include additional functionality without departing from the scope of the disclosure.

In one or more embodiments, the AIM (200) may also include an ejector handle (not shown). The ejector handle may include the functionality to lock the AIM (200) into the network switch chassis when the ejector handle is closed. In one or more embodiments, the ejector handle may include the functionality to facilitate AIM (200) removal when in an open position. The ejector handle may include additional functionalities without departing from the scope of the disclosure.

Turning to FIG. 2.2, FIG. 2.2 shows an isometric front view of an AIM (200) in accordance with one or more embodiments of the disclosure. In one or more embodiments, the AIM (200) may include a port array (203). The component is discussed further below.

In one or more embodiments, the front port array (203) contains multiple hardware connection points for external device connection. Additionally, the front port array (203) may include LEDs and other hardware capable of signaling status. The front port array (203) may include the functionality to relay the AIM (200) status via the LEDs, connect to external devices via the connection points, and receive and transmit data through the connection points. The front port array (203) may include additional functionality without departing from the scope of the disclosure. Further, in one or more embodiments the front port array (203) may be coplanar with the input-output (IO) end of the AIM.

Turning to FIG. 2.3, FIG. 2.3 shows an example AIM switchboard, the AIM Passthrough (AIM-P) (200) switchboard in accordance with one or more embodiments of the disclosure. In one or more embodiments, the AIM-P switchboard may include an AIM Edge Connector (202), multiple component connectors (e.g., 204, 208, 224-240), and a series of ports (e.g., 210-222). Each of these components is discussed below. In one or more embodiments, the AIM-P may be considered the default AIM associated the network switch (FIG. 1.1, 100). Other AIM versions (e.g., AIM-T) may be used as the default AIM without departing from the scope of the disclosure.

In one or more embodiments, the AIM-P Edge Connector (202) is hardware device that includes all of the functionality described in the AIM Edge Connector (FIG. 2.2, 202). Further, the AIM-P Edge Connector (202) may include the functionality to directly connect with the ports (210-222) via the circuitry (e.g., 208) without significant modification by intervening components (e.g., 206). The AIM-P Edge Connector (202) may include additional functionality without departing from the scope of the disclosure.

In one or more embodiments, the multiple component connectors (e.g., 204, 208, 224-240) may be circuitry similar to the circuitry in FIG. 1.2 (e.g., 136-154). The multiple component connectors (e.g., 204, 208, 224-240) may include additional functionality beyond the details provided in FIG. 1.2 without departing from the scope of the disclosure.

In one or more embodiments, the system LEDs (210) may include the functionality to output light to transmit visual information. As a non-limiting example, the information may be green light for good status, red light to indicate a problem. The system LEDs (210) may include additional signaling capabilities, such as other color displays or combinations of flashing colors, to indicate other system alerts. Further, the system LEDs (210) may display status conditions associated with the overall network switch (FIG. 1.1, 100) and/or the AIM. The system LEDs (210) may include additional functionality without departing from the scope of the disclosure.

In one or more embodiments, the USB A (212) is a common universal serial bus (USB) port capable of connecting to devices (e.g., end devices). In one or more embodiments, the USB A (212) includes the functionality to transmit data and power to connected devices. The USB A (212), in one or more embodiments, includes various data transfer speeds (e.g., USB 2.0, USB 3.0, USB 3.2, etc.). The USB A (212) may include additional functionality without departing from the scope of the disclosure.

In one or more embodiments, the remaining ports (214-222) are a variety of port types (e.g., console ports, ethernet ports, micro USB-B console ports, USB-C ports, light emitting diodes, etc.) The variety of ports, in one or more embodiments, are customizable based on client needs. As a non-limiting example, an AIM may include additional LEDs to indicate AIM or network switch specific information. Further, in one or more embodiments, the number of the remaining ports (214-222) is limited by the physical space available on the front port array (FIG. 2.2, 203). In one or more embodiments, the remaining ports (214-222) may include all of the listed port types (e.g., console ports, ethernet ports, micro USB-B console ports, USB-C ports, light emitting diodes, etc.), some, or different port types not listed without departing from the scope of the disclosure.

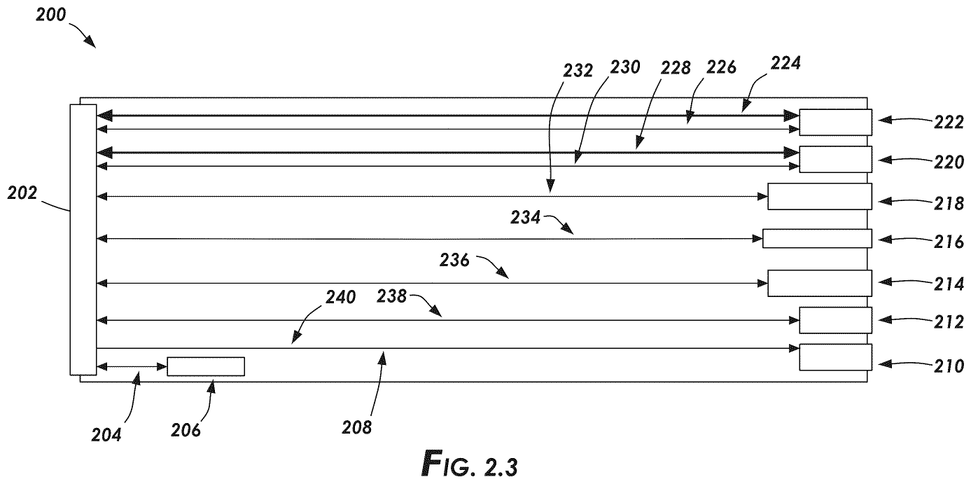

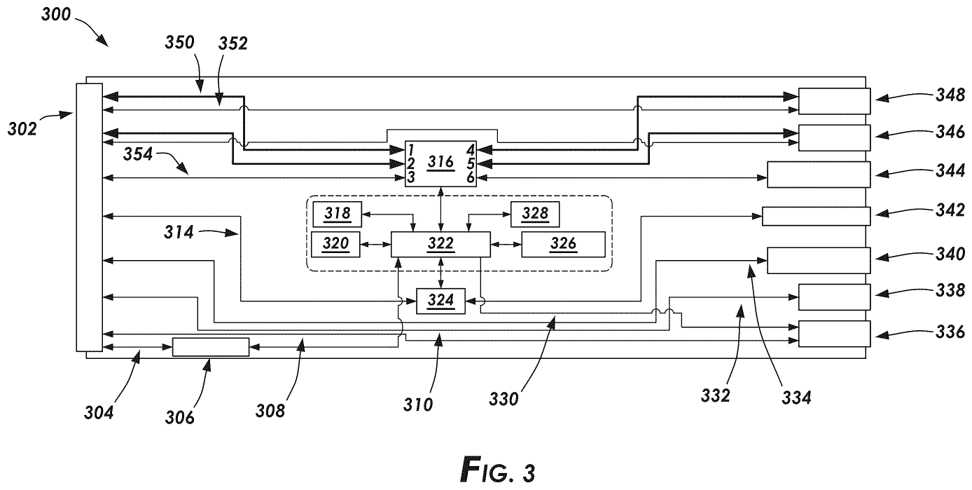

Turning to FIG. 3, FIG. 3 shows an AIM Telemetry (AIM-T) switchboard (300) in accordance with one or more embodiments of the disclosure. In one or more embodiments, the AIM-T switchboard (300) may include an AIM Edge Connector (302), a series of component connectors (e.g., circuitry (204, 308-314, 330-334, 350-354)), a multilayer switch (316), dynamic random access memory (DRAM) (318), boot flash (320), a processor (322), an FPGA (324), storage (326), a trusted platform module (TPM) (328), and a series of ports (336-348). In one or more embodiments, the AIM-T switchboard (300) may contain additional or fewer components without departing from the scope of the disclosure. Each component is discussed further below. The AIM-T switchboard (300) may include additional components in comparison to the AIM-P switchboard.

In one or more embodiments, the AIM-T (not shown) may include the functionality to perform network processing functionality separate from the network switch (FIG. 1.1, 100). As a non-limiting example, the AIM-T may include the functionality to redirect specific data flow from the NPU (FIG. 1.2, 134) to the multilayer switch (316) discussed below. The multilayer switch (316) may then process the redirected data flow before transmitting back to the network NPU for further processing or transmission. Further, the AIM-T may include an AIM operating system (AIM-OS) which, in conjunction with other components such as the processor (322), may include the functionality to use hardware acceleration to transform the data packets from the data flow and reinject the transformed data packets back to the NPU. The AIM-T and the AIM-OS may include additional functionality without departing from the scope of the disclosure.

In one or more embodiments, the AIM-T Edge Connector (302) is hardware device that includes all of the functionality described in the AIM Edge Connector (FIG. 2.2, 202). Further, the AIM-T Edge Connector (302) may include the functionality to connect with the ports (336-348) via the circuitry (e.g., 204, 308-314, 330-334, 350-354). The AIM-P Edge Connector (202) may include additional functionality without departing from the scope of the disclosure.

In one or more embodiments, the component connectors (e.g., 204, 308-314, 330-334, 350-354) may be circuitry similar to the circuitry in FIG. 1.2 (e.g., 136-154). In one or more embodiments, the component connectors (e.g., 204, 308-314, 330-334, 350-354) may connect to various internal components (e.g., multilayer switch (316)) instead of directly connecting the AIM-P Edge Connector (202) to the ports (336-348). The multiple component connectors (e.g., 204, 308-314, 330-334, 350-354) may include additional functionality beyond the details provided in FIG. 1.2 without departing from the scope of the disclosure.

In one or more embodiments, the multilayer switch (316) is hardware component capable of performing routing tasks associated with the AIM-T (300). The multilayer switch (316) includes the functionality, in one or more embodiments, to route traffic between various components, increase data transfer speeds, process larger and more complex networks, and provide more granular control over network traffic and access. In one or more embodiments, the multilayer switch (316) may include specialized hardware, such as application specific integrated circuits (ASIC) to optimize data packet forwarding. The multilayer switch (316) may include additional and/or fewer functionalities without departing from the scope of the disclosure.

In one or more embodiments, the DRAM (318) is a volatile computer memory that is capable of storing data and program code. In one or more embodiments, the DRAM (318) includes the functionality to rewrite the stored data to update the data. The DRAM (318) may include additional functionalities without departing from the scope of the disclosure.

In one or more embodiments, the boot flash (320) is a non-volatile flash memory capable of storing a bootloader. As used herein, a bootloader is a program that initializes a device at startup. In one or more embodiments, the boot flash (320) may contain additional start-up/boot related files. Further, in one or more embodiments, the boot flash (320) may include the functionality to store recovery files and instructions. The boot flash (320) may include additional functionalities without departing from the scope of the disclosure.

In one or more embodiments, the processor (322) is a physical hardware component capable of executing instructions and performing calculations. In one or more embodiments, the processor (322) includes the functionality to output instructions to other components in the Aim-T switchboard (300) via the circuitry. Further, the processor (322) may include the functionality to connect with, receive inputs, and transmit outputs to the network switch switchboard (FIG. 1.2, 120). Additionally, the processor (322), in one or more embodiments, includes the functionality to capture network switch telemetry information. The processor (322) may include additional functionality without departing from the scope of the disclosure.

In one or more embodiments, the FPGA (324) may be the same type of device and include similar functionality as the FPGA in FIG. 1.2 (132). In one or more embodiments, the FPGA (324) may include additional functionalities, including functionalities specific to the AIM-T (300) without departing from the scope of the disclosure.

In one or more embodiments, the storage (326) is a storage device (e.g., Solid State Devices (SSD)) capable of storing data associated with the network switch telemetry information. The storage (326), in one or more embodiments, also includes the functionality to store data associated with the AIM or other components in the AIM. The storage (326) may include additional functionality, such as functionality to serve as auxiliary storage for the network switch (FIG. 1.1, 100), without departing from the scope of the disclosure.

In one or more embodiments, the TPM (328) is a physical hardware component capable of securely storing cryptographic keys. By storing the keys, the TPM (328) includes the functionality to ensure authentication during secure boot processes and enable full encryption to enhance security. Further, in one or more embodiments, the TPM (328) may include verification functionality. Regarding the AIM-T specifically, the TPM (328) includes functionality to authenticate the AIM-T during installation on the network switch (FIG. 1.1, 100). The TPM (328) may include additional functionalities without departing from the scope of the disclosure.

In one or more embodiments, each port in the series of ports (336-348) may be a physical connection point where end devices (computers, printers, etc.) can connect to the network via the network switch (FIG. 1.1) once the AIM-T (300) is coupled to the network switch. Differing from the AIM-P (FIG, 2.3, 200), the series of ports on the AIM-T may include additional functionality or port type. As a non-limiting example, the AIM-T may include more ports for increased device connection.

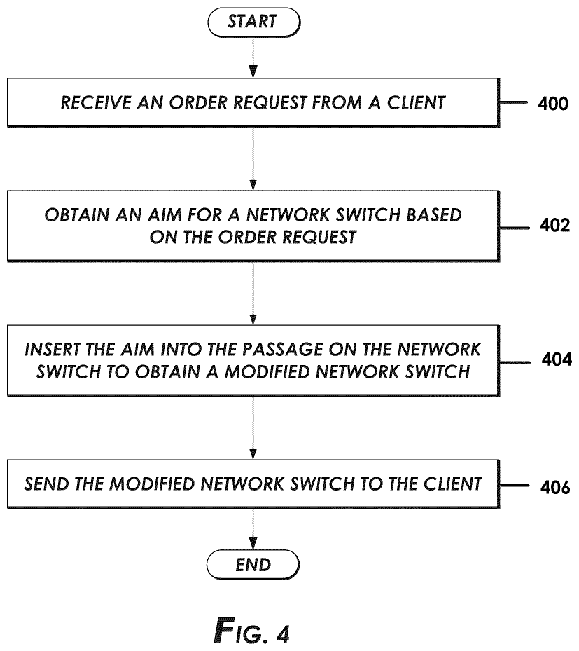

Turning now to FIG. 4, FIG. 4 shows a flowchart for a method for assembling a network switch with an AIM in accordance with one or more embodiments of the disclosure. The method shown in FIG. 4 may be performed by, for example, the manufacturer (not shown). Other components may perform all, or a portion, of the method of FIG. 4 without departing from the scope of the disclosure.

While FIG. 4 is illustrated as a series of steps, any of the steps may be omitted, performed in a different order, additional steps may be included, and/or any or all of the steps may be performed in a parallel and/or partially overlapping manner without departing from the scope of the disclosure.

In step 400, the manufacturer receives an order request from a client specifying specific networking capabilities. In one or more embodiments, the requested networking capabilities may be more than what is offered by the AIM-P. Further, the networking capabilities may be telemetry focused capabilities suitable for the AIM-T. Accordingly, in step 402, the manufacturer selects an AIM-T for the requested network switch based on the order request.

In step 404, the manufacturer installs the AIM-T into the network switch to obtain a modified network switch. In one or more embodiments, the installation process includes inserting the AIM-T into the passage (FIG. 1.1, 102) of the network switch, aligning the AIM Edge Connector (FIG. 2.1, 202) to the AIM Chassis Connector (FIG. 1.2, 158), and pushing the two components together to ensure a stable physical connection.

In step 406, after obtaining the modified network switch, the manufacturer sends modified network switch to the client. In one or more embodiments, after step 406, the method ends.

Embodiments of the disclosure may be implemented using computing devices. Turning to FIG. 5, FIG. 5 shows a diagram of a computing device (500) in accordance with one or more embodiments. The computing device (500) may include one or more computer processor(s) (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), input devices (510), output devices (512), and numerous other elements (not shown) and functionalities. Each of these components is described below.

In one embodiment, the computer processor(s) (502) may be an integrated circuit for processing instructions. For example, the computer processor(s) (502) may be one or more cores or micro-cores of a processor. The computing device (500) may also include one or more input devices (510), such as a touchscreen, access keyboard, mouse, microphone, touchpad, electronic pen, or any other type of input device. The communication interface (508) may include an integrated circuit for connecting the computing device (500) to a network (e.g., 102 in FIG. 1) (e.g., a local area network (LAN), a wide area network (WAN) such as the Internet, mobile network, or any other type of network) and/or to another device, such as another computing device.

In one embodiment, the computing device (500) may include one or more output devices (512), such as a screen (e.g., a liquid crystal display (LCD), a plasma display, touchscreen, cathode ray tube (CRT) monitor, projector, or other display device), a printer, external storage, or any other output device. One or more of the output devices (512) may be the same or different from the input devices (510). The input and output device(s) (410, 812) may be locally or remotely connected to the computer processor(s) (802), non-persistent storage (804), and persistent storage (806). Many diverse types of computing devices exist, and the aforementioned input and output device(s) (810, 812) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connection between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage module, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A network switch configured to receive an application interface module (AIM), the network switch comprising:
a chassis;
a network switchboard;
a plurality of fans coupled to the network switchboard;
a network processing unit (NPU) coupled to the network switchboard;
a field programmable gate array (FPGA) coupled to the network switchboard;
a plurality of network ports coupled to the NPU and the FPGA via a first connection path via the network switchboard and wherein the plurality of network ports are positioned along a front surface of the chassis; and
a passage extending from the front surface to an intermediate location between the front surface and a rear surface of the chassis,
wherein an AIM chassis connector is located at the intermediate location, and
wherein the AIM chassis connector is coupled to the NPU and the FPGA via a second connection path via the network switchboard separate from the first connection path.

2. The network switch of claim 1, wherein the network switch is operable without a device coupled to the AIM chassis connector.

3. The network switch of claim 2, further comprising:
a busbar connector configured to couple a remotely located power supply to the network switch.

4. The network switch of claim 1, further comprising:
the AIM coupled to the network switchboard via the AIM chassis connector, and wherein the passage is shaped to receive the AIM.

5. The network switch of claim 4, wherein an input-output (IO) end of the AIM is coplanar with the plurality of ports when the AIM is coupled to the AIM chassis connector.

6. The network switch of claim 5, wherein the IO end comprises a plurality of out-of-band management ports.

7. The network switch of claim 6, wherein the out-of-band management ports comprise at least one of: console ports, ethernet ports, universal serial bus (USB)-A ports, micro USB-B console ports, USB-C ports, and light emitting diodes (LEDs).

8. The network switch of claim 5, wherein the AIM further comprises:
a multilayer switch;
a dynamic random access memory;
an AIM CPU;
an AIM FPGA; and
a plurality of out-of-band management ports.

9. A network switch, comprising:
a chassis;
a network switchboard, wherein an application interface module (AIM) is removable from the network switchboard without removing any portion of the chassis;
a plurality of fans coupled to the network switchboard;
a network processing unit (NPU) coupled to the network switchboard;
a field programmable gate array (FPGA) coupled to the network switchboard;
a plurality of network ports coupled to the NPU and the FPGA via a first connection path via the network switchboard and wherein the plurality of network ports are positioned along a front surface of the chassis; and
a passage extending from the front surface to an intermediate location between the front surface and a rear surface of the chassis,
wherein an AIM chassis connector is located at the intermediate location, and
wherein the AIM chassis connector is coupled to the NPU and the FPGA via a second connection path via the network switchboard separate from the first connection path; and
the AIM coupled to the AIM chassis connector and wherein the AIM is within the passage, the AIM comprising:
a chassis with an open top and open back comprising:
a system side; and
an input-output (IO) side;
an AIM switchboard connected to the chassis such that the AIM switchboard sits between top and bottom planes of the chassis;
an AIM edge connector connected to the AIM switchboard and oriented on the system side;
a plurality of AIM network ports oriented on the IO side; and
a plurality of circuit paths inscribed on the AIM switchboard connecting the IO side to the system side.

10. The network switch of claim 9, wherein the AIM switchboard further comprises a multilayer switch, a processor, an operating system, and storage.

11. The network switch of claim 10, wherein the multilayer switch is configured to send data through the AIM to the plurality of network ports.

12. The network switch of claim 11, wherein the AIM is configured to modify the data prior to sending the data to the plurality of network ports.

13. The network switch of claim 10, wherein the processor is configured to capture network switch telemetry information and store the network switch telemetry information in the storage.

14. The network switch of claim 13, wherein the telemetry information comprises data traffic information, latency information, and encryption information.

15. The network switch of claim 9, wherein the plurality of AIM network ports are out-of-band with respect to the plurality of network ports.

16. The network switch of claim 15, wherein the AIM is replaceable without interrupting operations of the network switch.

17. A method for assembling a network switch, the method comprising:
inserting a network switchboard into a chassis of the network switch;
closing the chassis by coupling a chassis cover to the chassis, wherein the network switchboard is not accessible after closing the chassis, and wherein closing the chassis causes a passage to be defined through a portion of the network switch; and
inserting an AIM into the passage.

18. The method of claim 17, wherein the AIM inserted into the passage comprises an AIM-Passage (AIM-P).

19. The method of claim 17, wherein the AIM inserted into the passage comprises an AIM-Telemetry (AIM-T), and wherein the AIM-T comprises a processor, a multilayer switch, and a field programmable gate array (FPGA).

20. The method of claim 17, wherein inserting the AIM into the passage comprises locking an ejector handle on the AIM.
